(19) United States
(12) Patent Application Publication
(10) Pub. No.: US 2008/0248243 A1
(43) Pub. Date: Oct. 9, 2008

(54) LAMINATE THERMOPLASTIC SHEET, APPARATUS, AND METHOD

(76) Inventors: Eric S. Hausserman, Findlay, OH (US); Duane E. Jebbett, Findlay, OH (US)

Correspondence Address: FRASER CLEMENS MARTIN & MILLER LLC, 28366 KENSINGTON LANE, PERRYSBURG, OH, 43551, US

(21) Appl. No.: 12/062,049

(22) Filed: Apr. 3, 2008

Related U.S. Application Data
(60) Provisional application No. 60/910,287, filed on Apr. 5, 2007.

(51) Int. Cl. B32B 3/00; B32B 9/04; B32B 7/02; B29C 47/00; B32B 5/18

(52) U.S. Cl. 428/141; 428/411.1; 428/337; 428/319.7; 428/332; 156/443; 156/244.27

(57) ABSTRACT

A laminate thermoplastic sheet, and an apparatus and a method of making the sheet are disclosed. The laminate sheet has a substrate layer, a middle foam layer, and a cap layer bonded together. Each layer is chemically compatible with the others, thereby facilitating a recycling thereof. The apparatus and the method of producing the sheet includes extruding the cap layer, feeding a sheet foam material for the middle layer in substantial alignment with the cap layer; providing a roll assembly that compresses the cap layer and the middle layer together and forms a bond therebetween; extruding a thermoplastic substrate layer; and compressing the laminate and the substrate layer to form a bond therebetween and form a final three-layer laminate sheet.

### CROSS-REFERENCE TO RELATED APPLICATION

This application claims the benefit of U.S. Provisional Patent Application Ser. No. 60/910,287 filed on Apr. 5, 2007.

### FIELD OF THE INVENTION

The present invention relates to a laminate thermoplastic sheet, and more specifically to a laminate thermoplastic sheet having one surface that is compressible and resilient, wherein a material for each layer of the sheet is chemically compatible with the other layers to facilitate a recycling of the sheet.

### BACKGROUND OF THE INVENTION

Thermoplastic sheeting is widely used in the manufacture of various industrial and consumer products. The sheeting can be transformed into various three dimensional shapes by employing heat and a mold or a form having a desired final shape for the formed sheet. The heat is applied to the sheet causing the thermoplastic material of the sheet to become pliable. The pliable sheet is then caused to contact and conform to the mold or form. The formed sheet is cooled, causing the thermoplastic material to return to a substantially rigid state to retain the final desired shape.

The thermoplastic sheeting is often laminated with one or more sheets such as leather or vinyl, for example, to provide desired features to the product formed therefrom. For example, a substrate thermoplastic sheet can be laminated to a leather or a vinyl cap layer and a foam middle layer. The three layer laminate thermoplastic sheet can be formed into a desired shape as described above. Additionally, the cap layer can provide a desired exterior color or surface texture for the final product while, the foam middle layer can provide a compressible and resilient feel to the cap layer. Spartech Corporation offers such a three layered product under the brand name SoftTouch™.

The manufacture of laminate thermoplastic sheeting involves a number of separate steps to bond the diverse materials into a single sheet. The steps to achieve the final laminate sheet are typically completed by two or more separate manufacturers. For example, one manufacture may produce the cap and middle foam layer laminate sheet which sells the laminate to a second manufacturer. The second manufacturer produces the substrate sheet and bonds the laminate thereto to produce the final three layer laminate sheet. The multiple manufacturers typically involved with producing the final three layer laminate sheet increase a cost thereof.

Further, the different layers in the typical laminate thermoplastic sheet are not compatible with each other in respect of recycling. Scrap material from the sheets, non-conforming formed products, or formed products that are beyond a useful life must be disposed of in a landfill rather than recycled and used to produce new commercial or consumer products. The inability to recycle the laminated sheets increases the cost of the sheets and has long term environmental costs as waste disposal and consumption of natural resources are an ever increasing societal concern.

Manufacturing difficulties associated with the typical recyclable materials available for extruded laminate sheeting have prevented employing a recyclable material for each laminate in an extruded laminate sheet. The typical manufacturing equipment and the typical manufacturing processes are not adapted to utilize a recyclable material for each laminate in the extruded laminate sheet.

It would be desirable to provide a laminate thermoplastic sheet that has one surface which is compressible and resilient, employs chemically compatible materials so that the sheet can be recycled, and can be formed using a streamlined process which minimizes a manufacturing cost thereof.

### SUMMARY OF THE INVENTION

Compatible and attuned with the present invention, a laminate thermoplastic sheet that has one surface which is compressible and resilient, employs chemically compatible materials so that the sheet can be recycled, and can be formed using a streamlined process which minimizes a manufacturing cost thereof has surprisingly been discovered.

In one embodiment, a laminate thermoplastic sheet comprises a substrate layer formed from a recyclable thermoplastic; a middle layer formed from a recyclable resilient material, the middle layer bonded to the substrate layer; and a cap layer formed from a recyclable thermoplastic elastomer, the cap layer bonded to the middle layer, wherein the substrate layer, the middle layer, and the cap layer are chemically compatible to facilitate a recycling of the sheet.

In another embodiment, an apparatus for producing a laminate thermoplastic sheet comprises an extruder for forming a substantially planar sheet formed from a recyclable thermoplastic; an unwind station adapted to dispense a substantially planar sheet of material adjacent and in substantial alignment with the extruded sheet, wherein a surface of the dispensed sheet of material is caused to contact and form a bond with a surface of the extruded sheet to form a laminate sheet thereof; a roll assembly including at a least a pair of rollers, each roll having an outer surface, the outer surfaces cooperating to compress the laminate therebetween to facilitate forming the bond between the dispensed sheet and the extruded sheet; and one of a winding station and a cutting station adapted to receive the sheet.

In another embodiment, a method for producing a laminate thermoplastic sheet comprises the steps of extruding a thermoplastic elastomer cap material into a sheet; feeding a foam material adjacent and in substantial alignment with the cap material; compressing the foam material and the cap material to create a bond and form a laminate thereof; extruding a thermoplastic substrate material into a sheet adjacent and in substantial alignment with the laminate; and compressing the substrate material and the laminate to create a bond and form a final laminate sheet.

### BRIEF DESCRIPTION OF THE DRAWINGS

The above, as well as other advantages of the invention, will become readily apparent to those skilled in the art from the following detailed description of an embodiment of the invention when considered in the light of the accompanying drawings, in which:

FIG. 1 is a perspective view of a laminate thermoplastic sheet according to an embodiment of the invention with a portion cut-away to more clearly illustrate each laminate;

FIG. 2 is a schematic side elevational illustration of an apparatus for producing the laminate thermoplastic sheet illustrated in FIG. 1;

FIG. 3 is a schematic top plan view of the apparatus shown in FIG. 2;

FIG. 4 is a schematic side elevational illustration of the apparatus illustrated in FIGS. 2 and 3 including a cutting mechanism for cutting the laminate thermoplastic sheet illustrated in FIG. 1; and

FIG. 5 is a schematic top plan view of the apparatus shown in FIG. 4.

### DETAILED DESCRIPTION OF THE PREFERRED EMBODIMENT

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

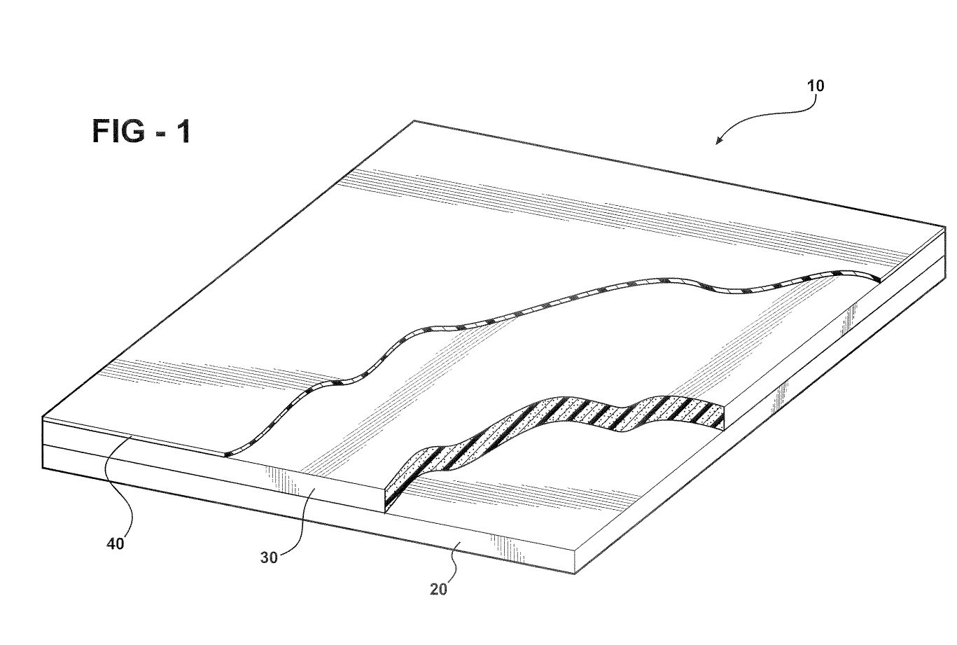

A laminate thermoplastic sheet, generally indicated by reference numeral 10, is shown in FIG. 1. The sheet 10 includes a substrate layer 20 having a first side and a spaced apart second side. The substrate layer 20 is formed by extruding a recyclable, thermoplastic, thermoformable, high impact, polypropylene resin as a substantially planar sheet. The resin includes a base resin. Favorable results have been obtained using the base resin E3000 from Solvay Engineered Polymers. It should be understood that other base thermoplastic resins can be used as desired. Additives can be included with the base resin such as colorants, processing aides, and impact modifiers, for example. Additionally, a regrind can be included with the base resin. It should be understood that regrind is a scrap thermoplastic composite collected in-plant or from post-consumer sources that are reground into pellets or fine powder for use in a newly extruded substrate layer 20. In the embodiment shown, a thickness of the substrate layer 20 is about 0.100 inches. It should be understood that other thicknesses can be used as desired.

A middle layer 30 of the sheet 10 is formed from a recyclable foam or a compressible resilient material having a first side and a spaced apart second side. The foam is typically a cross-linked, closed cell polypropylene foam. Favorable results have been obtained using four pound 0.059 inch thick LS Natural foam from Sekisui Voltek, LLC. It should be understood that other cross-linked, closed cell polypropylene foams can be used as desired, including those having other thicknesses. The second side of the middle layer 30 is bonded to the first side of the substrate layer 20.

A cap layer 40 for the sheet 10 is formed by extruding a recyclable, thermoplastic, elastomer resin as a substantially planar sheet having a first side and a spaced apart second side. The resin includes a base resin. Favorable results have been obtained using the base resin EX4290 TPE from Solvay Engineered Polymers. It should be understood that other base thermoplastic, elastomer resins can be used as desired. Additives can be included with the base resin such as colorants, processing aides, and UV stabilizers, for example. In the embodiment shown, a thickness of the cap layer is about 0.020 inches. It should be understood that other thicknesses can be used as desired. The second side of the cap layer 40 is bonded to the first side of the middle layer 30. Additionally, the first side of the cap layer 40 may include an embossed or textured finish formed thereon, if desired.

The three layer laminate thermoplastic sheet 10 is adapted to be formed into a variety of shapes for use in commercial and consumer products. The sheet 10 is formed into the various shapes by employing heat and a mold or a form having a desired final shape for the formed sheet. The heat is applied to the sheet 10 causing the sheet 10 to become pliable. The pliable sheet 10 is then caused to contact and conform to the mold or form. The formed sheet is cooled causing a return to a substantially rigid state to retain the final desired shape.

The cap layer 40 can be adapted to provide a desired decorative exterior finish to the end product by selectively providing the color and the embossed finish thereto. The foam middle layer 30 imparts a compressible and resilient or soft feel to the cap layer 40. The substrate layer 20 provides rigidity and strength to the sheet 10 and any end product made therefrom.

The physical properties of the three layers 20, 30, 40 of the sheet can be individually customized as required by the end product which is formed therefrom. As discussed above, the color and the UV resistance, for example, of the cap layer 40 can be modified as desired. The thickness and density of the foam used for the middle layer 30 can be adjusted to obtain a desired softness to the cap layer 40. Further, the thickness and impact strength of the substrate layer 20 can be modified to provide a required weight and a durability to the end product, for example.

The chemical properties of the material used in each of the three layers 20, 30, 40 are compatible in respect of recycling. Regrind can be formed from scrap of the sheets 10. The regrind can be used as a filler material in the substrate layer 20 for example. Favorable results have been obtained using up to 40% by weight of regrind in the substrate layer 10. It should be understood that other percentages of regrind can be used in the substrate layer 20 as desired. Recycling the scrap from the sheet 10 back into the substrate layer 20 substantially eliminates the need to place such scrap in a landfill, and minimizes the financial and environmental costs associated with disposing of the scrap in a landfill.

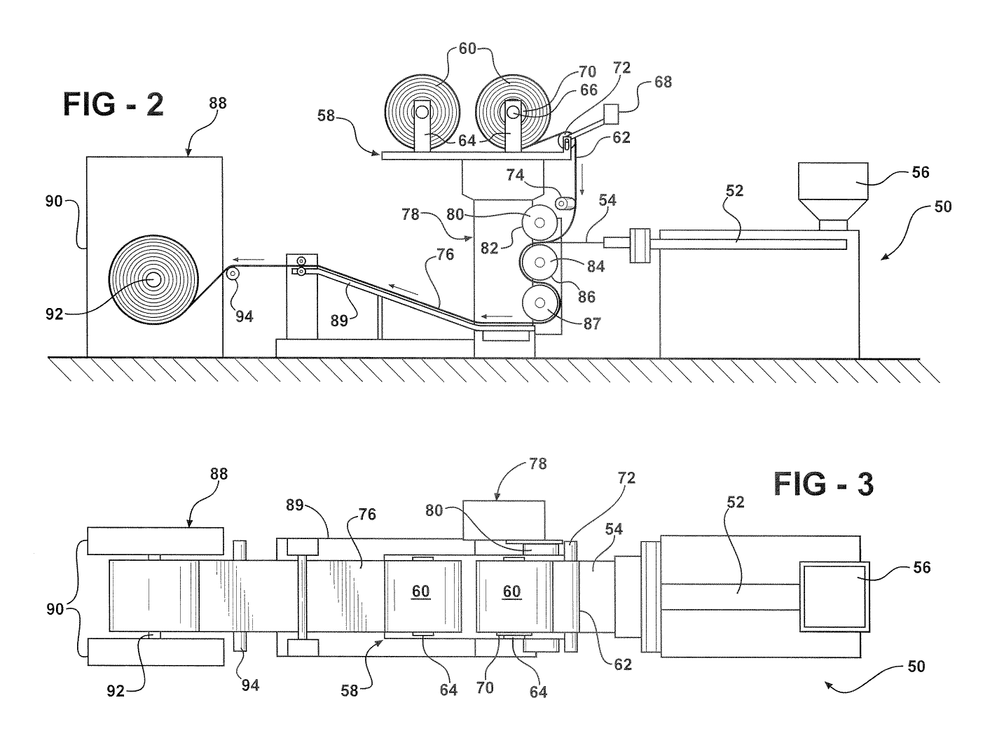

An apparatus for producing the laminate thermoplastic sheet 10 is shown in FIGS. 2-5. The apparatus 50 includes an extruder 52 adapted to receive a base resin and extrude a substantially continuous and planar cap sheet 54 that forms the cap laminate 40 of the sheet 10. Favorable results have been found using a screw type extruder to form the cap sheet 54 having a thickness of 0.020″. It should be understood that other methods now known or later developed can be employed to form the cap sheet 56. Additionally, it should be understood that other thicknesses can be employed as desired to achieve a desired strength or other desired physical property of the cap sheet 54.

The resin for the cap sheet 54 is typically provided to the extruder through a feed hopper 56 that blends the base resin with any other ingredients in a predetermined ratio utilizing a computerized control system. Favorable results have been obtained employing a feed hopper 54 supplied by The Conair Group, Inc. of Cranberry Township, Pennsylvania.

An unwind station 58 is provided adjacent where the cap sheet 54 emerges from the extruder 52. The unwind station 58 is adapted to hold a roll 60 of a recyclable foam 62 that forms the middle laminate 30 of the sheet 10. The unwind station 58 shown includes a structural frame 64 adapted to support a three inch or a six inch rotating expandable air shaft 66 having lateral location control. The shaft 66 is adapted to receive the roll 60 and dispense the foam 62 therefrom in substantial horizontal alignment with the cap sheet 54. In the embodiment shown, two foam roll stations are provided to facilitate a quick change of the rolls 60, thus minimizing any stopping of the extrusion of the cap sheet 54. Additionally, a laser guiding system 68 can be included to facilitate the aligning of the foam 62 with the cap sheet 54.

The shaft 66 includes a brake system 70 adapted to maintain a desired rotational velocity of the shaft 66 and a desired tension on the foam 62. Favorable results have been found using a brake system 70 having a twelve inch disc and two one-and-a-half inch calipers. The brake system 70 includes brake force adjustment means that is accessible by an operator of the apparatus 50 to adjust the braking force provided to the shaft 66.

An idler bar 72 is provided with the unwind station 58 that facilitates a control of the tension of the foam 62 as it is unwound. A bow bar 74 is provided adjacent the idler bar 68. The bow bar 74 has a generally arcuate shape, wherein the foam 62 is drawn across the bow bar 74 to militate against wrinkles forming in the foam 62 as the foam 62 is unwound from the roll 60.

The unwind station 58 causes the foam 62 to unwind from the roll 60 and causes a second side of the foam 62 to contact a first side of the cap sheet 54 being extruded, the two sides being in substantial alignment and forming a laminate 76 thereof.

The cap 54 and the foam 62 laminate 76 is fed through a roll assembly, generally indicated by reference numeral 78. The roll assembly 78 includes at least a pair of rollers 80, 84 wherein an outer surface 82, 86 of the rollers 80, 84, respectively, are spaced apart at a selected distance to receive the laminate 76 therebetween. It should be understood that the selected distance between the respective outer surfaces 82, 86 of the rollers 80, 84 can be adjusted to accommodate laminates having different thicknesses. One of the rollers 80, 84 can be provided with a textured finish on the outer surfaces 82, 86 adapted to emboss a finish texture on a first surface of the cap sheet 54. It should be understood that the roll assembly can be adapted to change at least one of the rolls 80, 84 to provide a desired finish texture to the first surface of the cap sheet 54. The roll assembly 72 compresses the cap sheet 54 and the foam 62 together to facilitate a bonding therebetween. The application of the foam 62 to the cap sheet 54 immediately after extrusion and before entering the roll assembly 72 maximizes a bond therebetween. The roll assembly 72 also includes a cooling roll 87 adapted to transfer a heat energy from the laminate 76. It should be understood other means can be used with the cooling roll 87 or in place of the cooling roll 87 to absorb the heat energy from the laminate 76.

A conveyor 89 is provided to support the laminate 76 from the roll assembly 78 to a winding station 88. A plurality of trim knives (not shown) can be provided that cooperate with conveyor 89 to trim a longitudinal edge of the laminate 76. The winding station 88 is adapted to receive the laminate 76 and wind the laminate into a roll. The winding station 88 includes a structural frame 90 to support a three inch or a 6 inch rotating expandable air shaft 92. A lay on roll 94 is provided to facilitate an even lay of the laminate 76 as it is wound unto the shaft 92. An even lay is defined as the edges of the laminate being in substantial alignment from layer to layer on the shaft 92, and the surfaces of the laminate 76 being substantially wrinkle free. A laser guiding system (not shown) can be provided to facilitate the even lay of the laminate 74 on the shaft 92 of the winding station 88. Favorable results have been obtained employing a means to quick change the shaft 92 upon receiving a desired length of the laminate 78, thus minimizing any stopping of the apparatus 50.

The shaft 92 from the winding station 88 having the laminate 76 wound thereon is adapted to be removed from the winding station 88 and transferred to the unwinding station 58. The unwinding station 58 positions the laminate 76 for the production of the final three layer laminate thermoplastic sheet 10. It should be understood that the shafts 66, 92 of the unwinding station 58 and the winding station 88 are interchangeable to facilitate the transfer of the roll of the laminate 76 therebetween.

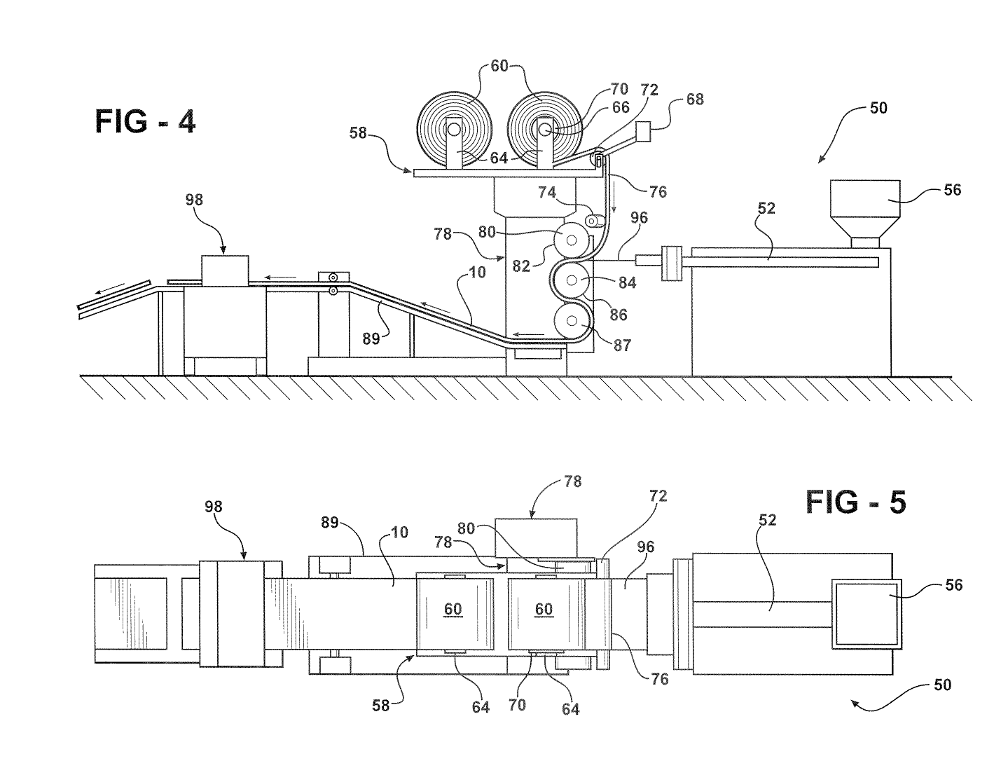

In FIGS. 4 and 5, the apparatus 50 is shown adapted to utilize the laminate 76 to produce the final laminate sheet 10. However, it should be understood that a second apparatus can be employed to produce the final laminate sheet 10. Additionally, the second apparatus could be positioned adjacent the conveyor 89 to receive the laminate 76 directly from the apparatus shown in FIGS. 2-3.

The extruder 52 extrudes a substrate sheet 96 that forms the substrate laminate 20 in the sheet 10. The base resin for the substrate sheet 96 is typically provided to the extruder 52 through the feed hopper 56 that blends the base resin with any other desired ingredients in a predetermined ratio utilizing a computerized control system. It should be understood that the regrind can be added to the resin at the feed hopper 56. The unwind station 58, previously described herein, is employed to dispense the laminate 76 in substantial alignment with the substrate sheet 96. The foam 62 of the laminate 76 is caused to contact a second side of the substrate sheet 96, thereby forming the final three layer laminate thermoplastic sheet 10.

The sheet 10 is fed through the roll assembly 78 to compress the laminate 78 to the substrate sheet 96 to facilitate a bonding therebetween. Typically, the outer surfaces 82, 86 of the respective rolls 80, 84 do not include means for embossing a texture to the substrate sheet 96 to produce a substrate sheet having a substantially smooth surface. However, an embossed surface can be formed on the substrate sheet by employing at least one roll 80, 84 with a textured outer surface 82, 86, if desired. The application of the laminate 76 to the substrate sheet 20 immediately after extrusion thereof and before entering the roll assembly 78 maximizes a bond therebetween.

The final three layer laminate thermoplastic sheet 10 is then supported by the conveyor 89 to a means for cutting 98 adapted to cut the sheet 10 into individual panels or sheet stock having a desired width and length. It should be understood that the winding station 88 illustrated in FIGS. 2 and 3 is removed from the apparatus 50, and the means for cutting 98 is substituted therein. The sheet stock can then be uniformly stacked and packaged as desired for shipping to a customer. Favorable results have been obtained employing a shearing device to cut the sheet 10. However it should be understood that other means may be employed to cut the sheet 10 such as a rotating cutting blade or a stationary cutting blade, for example. It should be understood that a photo eye system or other dimensional monitoring system such as a camera system, for example, can be provided to facilitate an accurate and repeatable cutting process. It should also be understood that the final laminate sheet 10 can be wound on a roll in a continuous sheet rather than cut into sheet stock.

The apparatus and method for producing the three layer laminate thermoplastic sheet 10, described herein, minimizes a cost thereof by simplifying the manufacturing process and the costs associated with the typical manufacturing process of plastic laminates that require multiple manufacturers. Further, by joining the layers when the extruded layers 20, 40 first emerge from the extruder 52 at an elevated temperature, the bond created is maximized, which maximizes the overall quality and durability of the three layer laminate thermoplastic sheet 10.

From the foregoing description, one ordinarily skilled in the art can easily ascertain the essential characteristics of this invention, and without departing from the spirit and scope thereof, can make various changes and modifications to the invention to adapt it to various usages and conditions.

What is claimed is:

1. A laminate thermoplastic sheet comprising:
a substrate layer formed from a recyclable thermoplastic;
a middle layer formed from a recyclable resilient material, the middle layer bonded to the substrate layer; and
a cap layer formed from a recyclable thermoplastic elastomer, the cap layer bonded to the middle layer, wherein the substrate layer, the middle layer, and the cap layer are chemically compatible to facilitate a recycling of the sheet.

2. The sheet according to claim 1, wherein the recyclable thermoplastic includes a polypropylene base resin.

3. The sheet according to claim 2, wherein at least one of a colorant, processing aid, and an impact modifier is included with the base resin.

4. The sheet according to claim 1, wherein the recyclable thermoplastic includes a regrind material.

5. The sheet according to claim 1, wherein a thickness of the substrate layer is about 0.10 inches.

6. The sheet according to claim 1, wherein the recyclable resilient material is a polypropylene foam.

7. The sheet according to claim 1, wherein a thickness of the middle layer is about 0.059 inches.

8. The sheet according to claim 1, wherein the recyclable thermoplastic elastomer includes a base resin.

9. The sheet according to claim 8, wherein at least one of a colorant, processing aid, and a UV stabilizer is included with the base resin.

10. The sheet according to claim 1, wherein a thickness of the cap layer is about 0.020 inches.

11. The sheet according to claim 1, wherein the cap layer includes a pair of spaced apart surfaces, at least one of the surfaces having a texture formed thereon.

12. An apparatus for producing a laminate thermoplastic sheet comprising:
an extruder for forming a substantially planar sheet formed from a recyclable thermoplastic;
an unwind station adapted to dispense a substantially planar sheet of material adjacent and in substantial alignment with the extruded sheet, wherein a surface of the dispensed sheet of material is caused to contact and form a bond with a surface of the extruded sheet to form a laminate sheet thereof;
a roll assembly including at a least a pair of rollers, each roll having an outer surface, the outer surfaces cooperating to compress the laminate therebetween to facilitate forming the bond between the dispensed sheet and the extruded sheet; and
one of a winding station and a cutting station adapted to receive the sheet.

13. The apparatus according to claim 12, wherein the unwind station includes a structural frame to support a shaft for removably supporting and rotationally dispensing the material therefrom.

14. The apparatus according to claim 13, wherein the unwind station includes at a least one of an idler bar adapted to facilitate a control of a tension in the dispensed material and a bow bar adapted to militate against a wrinkle from forming in the dispensed material.

15. The apparatus according to claim 13, wherein the unwind station includes a brake system adapted to maintain at a least one of a desired rotational velocity of the shaft and a desired tension in the dispensed material.

16. The apparatus according to claim 12, wherein the rollers are adapted to form a texture on a surface of the extruded sheet.

17. The apparatus according to claim 12, wherein the roll assembly includes means for removing a heat energy from the laminate.

18. The apparatus according to claim 12, wherein the winding station includes a structural frame to support a shaft for windably receiving the laminate thereon.

19. The apparatus according to claim 12, wherein the cutting station includes means for cutting the laminate into a plurality of panels having a desired width and length.

20. A method for producing a laminate thermoplastic sheet comprising the steps of
extruding a thermoplastic elastomer cap material into a sheet;
feeding a foam material adjacent and in substantial alignment with the cap material;
compressing the foam material and the cap material to create a bond and form a laminate thereof;
extruding a thermoplastic substrate material into a sheet adjacent and in substantial alignment with the laminate; and
compressing the substrate material and the laminate to create a bond and form a final laminate sheet.
